(19) United States
(12) Patent Application Publication
(10) Pub. No.: US 2006/0095324 A1
(43) Pub. Date: May 4, 2006

(54) Electronic capture of promotions

(76) Inventors: David Lyn Vergeyle, Long Lake, MN (US); David C. McClanahan, Portland, OR (US); Barry M. Pon, Millbrae, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/982,326

(22) Filed: Nov. 4, 2004

(51) Int. Cl. G06Q 30/00

(52) U.S. Cl. 705/14

(57) ABSTRACT

Promotional content is electronically displayed on section directories placed throughout a store. A consumer captures one of the displayed promotions by providing consumer identification or other input at a consumer interface device located in the section corresponding to the directory which displays the promotion. The consumer identification is then associated with the promotion. This association is then integrated with the store's point-of-sale (POS) systems, such that when the consumer presents a product associated with the promotion for purchase at the POS, the POS applies the promotion (e.g. discount) to the sale. In one aspect, a section directory is placed within an aisle.

### TECHNICAL FIELD

This disclosure relates generally to the electronic capture of promotions, and in particular but not exclusively, relates to the electronic capture of promotions displayed on electronic displays.

### BACKGROUND OF THE INVENTION

Promotions are often displayed in commercial settings, such as in a grocery store. Typically, such promotions may appear on printed signage proximate to the goods to which the particular promotion may apply to. For example, printed coupon dispensers may be placed in an aisle near the physical location of the goods associated with the coupon. A consumer is then required to take the printed coupon along with the associated goods to the checkout or point-of-sale (POS), where the consumer presents both the coupon and goods prior to completing the sale. One disadvantage with this system is that the consumer must retain the physical coupon for each item while shopping, which may be cumbersome to a shopper having many items. Furthermore, the consumer is required to present each coupon at checkout, requiring the POS attendant to manually sort through the coupons to determine applicability prior to processing them, which can increase the time a consumer spends at checkout.

In addition, advertisers and promoters are often concerned with attracting and maintaining consumer interest in a promotion for an associated product. In an attempt to attract consumer attention, much effort is put into developing both printed and electronic graphical displays that are visually attractive. Consequently, consumers are often exposed to numerous promotional materials upon entering a grocery store, which may lead to complacency when presented with a promotion. Thus, there is a need to maintain the consumer's attention once the promotion has been presented to them, such that the consumer is compelled to perform some action related to the promotion, such as obtaining a coupon or purchasing specific goods.

### SUMMARY OF THE DESCRIPTION

The present invention relates to electronic capture of coupons. In one embodiment of the invention, promotional content is electronically displayed on aisle directories placed throughout a store. A consumer may capture one of the displayed promotions by providing consumer identification or other input at a consumer interface device located in the aisle corresponding to the aisle directory which displays the promotion. The consumer identification is then associated with the promotion. This association is then integrated with the store's point-of-sale (POS) systems, such that when the consumer presents a product associated with the promotion for purchase at the POS, the POS applies the promotion (e.g. discount) to the sale.

The present invention is described in conjunction with systems, clients, servers, methods, and machine-readable media of varying scope. In addition to the aspects of the present invention described in this summary, further aspects of the invention will become apparent by reference to the drawings and by reading the detailed description that follows.

### DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates a system level overview of an embodiment of a promotion capture system.

FIG. 2 illustrates an embodiment of an aisle directory 200.

FIG. 3 illustrates an embodiment of an electronic promotion capture method.

FIG. 4 illustrates an embodiment of a back office tool set.

FIG. 5A illustrates an embodiment of an operating environment suitable for practicing the present invention.

FIG. 5B illustrates an embodiment of a computer system suitable for use in the operating environment of FIG. 5A.

### DETAILED DESCRIPTION

In the following detailed description of embodiments of the invention, reference is made to the accompanying drawings in which like references indicate similar elements, and in which is shown by way of illustration specific embodiments in which the invention may be practiced. These embodiments are described in sufficient detail to enable those skilled in the art to practice the invention, and it is to be understood that other embodiments may be utilized and that logical, mechanical, electrical, functional, and other changes may be made without departing from the scope of the present invention. The following detailed description is, therefore, not to be taken in a limiting sense, and the scope of the present invention is defined only by the appended claims.

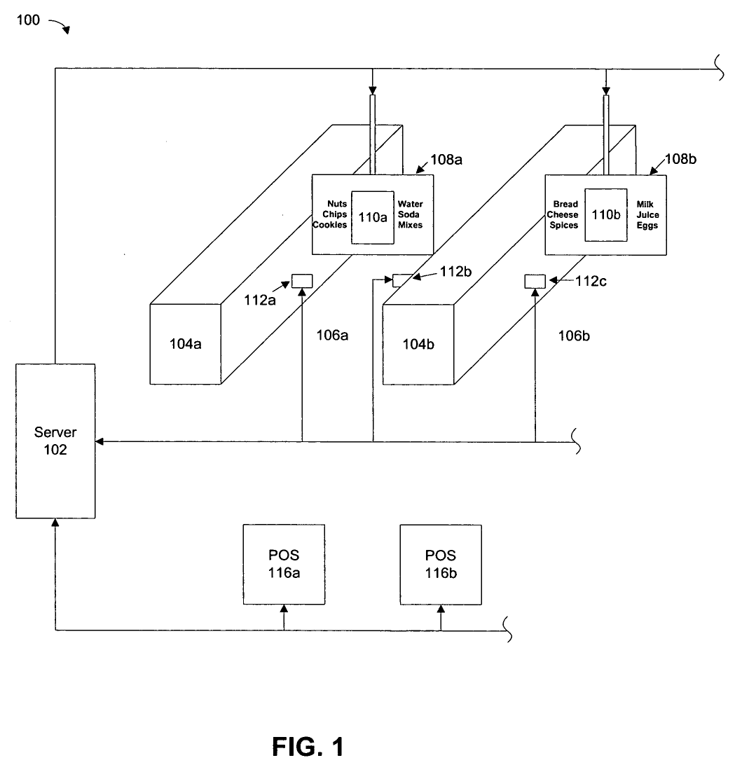

FIG. 1 illustrates a system level overview of an embodiment of the invention. According to an embodiment of the invention, promotional content is electronically displayed on aisle directories placed throughout a store. A consumer may capture one of the displayed promotions by providing consumer identification or other input at a consumer interface device located in the aisle corresponding to the aisle directory which displays the promotion. The consumer identification is then associated with the promotion. This association is then integrated with the store's point-of-sale (POS) systems, such that when the consumer presents a product associated with the promotion for purchase at the POS, the POS applies the promotion (e.g. discount) to the sale.

For purposes of clarity, embodiments of the present invention will be described primarily with respect to a grocery store environment; however, it will be understood that embodiments of the present invention are not limited to such an environment, and instead are applicable to a wide variety of commercial environments, such as retail stores, wholesale warehouses, and other locations or environments where commerce may be transacted.

In one embodiment, a promotion capture system 100 includes a server 102 communicatively coupled to aisle directories 108a, 108b, consumer interface devices 112a, 112b, 112c, and point-of-sale (POS) terminals 116a, 116b. In other embodiments, various elements of the system 100 may be communicatively coupled to each other directly, without passing through server 102. For example, in one embodiment, consumer interface device 112a is communicatively coupled to the aisle directory 108a. In one embodiment, server 102 is remote from the store or location in which the aisle directory is located. In another embodiment, server 102 is located within the store or location in which the aisle directory is located. Aisle directories 108a, 108b are graphical displays that typically are hung above an aisle 106a, 106b to assist a consumer in locating items within the store. In a grocery store or supermarket, for example, an aisle 106a is formed between two product shelves 104a and 104b. Shoppers typically access goods placed on the shelves 104a, 104b by traversing an aisle 106a. In one embodiment, each aisle directory 108a, 108b is signage that lists the types of items or goods that may be found on its respective aisle. For example, aisle directory 108a lists items such as Nuts, Chips and Cookies, which may be found on the portion of product shelf 104a facing aisle 106a. In one embodiment, each aisle directory 108a, 108b includes an electronic display device 110a, 110b. The electronic display device 110a, 110b may be a liquid crystal (LCD) display, a cathode ray tube (CRT) monitor, or other types of well-known electronic display devices. In one embodiment, each display device 110a, 110b may display content associated with more than one promotion at a time.

In one embodiment, server 102 controls the content that is presented on the electronic displays 110a, 110b of each aisle directory 108a, 108b. In one embodiment, promotional content is displayed on the electronic displays. Promotional content includes content describing promotional events such as general product or service advertising, discount offers such as coupons, and sweepstakes or contest entries, among other types of promotions. For example, the promotional content may be advertising for a new product.

In one embodiment, the promotional content is designed to attract the consumer's attention, in order to entice the consumer to enter the aisle or purchase a particular product. The content displayed on display devices 110a, 110b may include graphical content, such as for example, full-motion video, animations, graphics stills, or vector-based graphics (e.g. JPEG, GIF images, etc.). In one embodiment, a combination of graphics and motion are used to draw the attention of consumers. In another embodiment, an audio output device, such as a speaker, may be associated with the promotional content displayed on the display devices 110a, 110b.

In one embodiment, server 102 assigns different promotional content to be displayed for each aisle 106a, 106b. In one embodiment, server 102 assigns promotional content based on the types of goods that are located on the particular aisle. For example, server 102 may cause promotional content to be displayed on display device 110a describing a savings coupon available on a particular Chips product, while server 102 simultaneously causes promotional material to be displayed on display device 110b describing a “Buy One, Get One Free” promotion for a particular Bread product. In one embodiment, either the display 110a, 110b or another portion of the aisle directory 108a, 108b includes content directing the consumer to interact with the consumer interface device 112a, 112b. In another embodiment, the promotional content displayed on the display device 110a, 110b is rotated or changed periodically. For example, the particular promotion displayed may change every few minutes, hourly, daily, weekly, etc.

In another embodiment, a display 110a displays promotional content for products located elsewhere than on the particular aisle or section in which the display 110a may be located. For example, the promotional material may be associated with products or services available at another business or location.

When a consumer is presented with promotional content displayed on one of the electronic display 110a of the aisle directory 108a, for example while shopping or traversing an aisle, the consumer may desire to participate in the promotion. In one embodiment, where a promotion is displayed on display 110a, a consumer is able to participate in the promotion (also referred to as capturing the promotion) by providing information to a consumer interface device 112a located on shelf 104a of aisle 106a.

In one embodiment, the consumer interface device 112a, 112b includes or is proximate to content directing the consumer to interact with the consumer interface device 112a, 112b to capture the promotion displayed on the display device 110a.

In one embodiment, the consumer interface device 112a, 112b is an interactive device for accepting input from the consumer. The input may be information from, about or associated with the consumer. In one embodiment, the input information is used to identify the consumer in order to associate the promotion with the consumer. In one embodiment, the consumer interface device includes a keypad or other input device for accepting input from the user. The information may be provided by the consumer through presenting a card to the consumer interface device, such as a magnetic strip card, a smart card, or a card including a barcode. For example, in one embodiment, the reader may be a magnetic strip reader for reading information stored on cards having magnetic strips. In another embodiment, the reader is an optical reader, such as for reading barcodes. In yet another embodiment, a contactless card may be used, such as a card including a radio frequency identification (RFID) chip. In one embodiment, the consumer interface device includes a biometric identification interface, such as a fingerprint reader. The input received from the consumer at the consumer interface device may include the consumer's name, phone number, account number, personal identification number (PIN), or other information identifying the consumer. For example, a consumer may capture the promotion by swiping a customer loyalty or rewards card through a reader on the consumer interface device 112a. In one embodiment, a consumer may be assigned an account number or other identifying information by signing up with the store beforehand. Alternatively, in one embodiment, a consumer may sign up for the store's loyalty program through the consumer interface device 112a.

In one embodiment, there are a plurality of consumer interface devices located in aisle 106a. For example, in one embodiment, there are two consumer interface devices 112a, 112b on a single aisle 106a, one disposed on each side of the aisle 106a. In another embodiment, there may be a plurality of consumer interface devices on each side of an aisle. The consumer interface devices may be fixed, or moveable. For example, in one embodiment, the consumer interface device may be carried by the consumer or attached to a shopping cart. In such embodiments, the mobile consumer interface device is capable of determining the most proximate display device 110a, so that the proper promotion may be captured by the consumer. In one embodiment, the consumer interface device is coupled to a power source in addition to the server 102.

After receiving input from the consumer, the information received at the reader 112a is transmitted to the server 102 for processing. In another embodiment, the information received at the reader 112a is transmitted first to the directory 108a, then to the server 102. The reader 112a is communicatively coupled to the server 102 through either a wired connection or a wireless connection. In one embodiment, server 102 associates the information received at reader 112a with a consumer identification, such as a consumer account number. The server 102 then determines which promotion to associate with the consumer identification. In one embodiment, the server 102 associates the consumer identification with the promotion displayed when the consumer information was provided. Thus, for example, in one embodiment, where display 110a presents a coupon for 50% off of a particular Cookie item, the consumer may capture the coupon by swiping a magnetic loyalty card at the consumer interface device 112a while the promotion for the coupon is currently displayed on the display device 112a. In one embodiment, this relationship between the currently displayed promotion and the ability to consumer interface device may entice the consumer to capture the coupon or promotion before the display 112a ceases displaying the promotion, or displays another promotion. By capturing the coupon or promotion, it is meant that the promotion is associated with the consumer identification.

In one embodiment, once determining which promotion to associate with the consumer identification, the server 102 activates or initiates the particular promotion for the consumer identification, for example, by turning on a flag, so that the store's POS system is able to determine whether to apply the promotion if the consumer performs the conditions required for the promotion (e.g. purchasing a particular product or combination of products).

In an alternate embodiment, the consumer interface device 112a may present the consumer with a choice of a plurality of available promotions which may be captured. For example, in one embodiment, a consumer interface device 112a may present a consumer with a choice of selecting one (or more) of several promotions that were recently displayed promotions, e.g. a choice of the promotions displayed within the last ten minutes. In an alternate embodiment, the consumer interface device 112a may present the consumer with an input field to enter information identifying the particular promotion the consumer wants to capture. In an exemplary embodiment, the promotional content presented on display 110a may include information on how to identify the promotion to the consumer interface device, such as for example “Enter Code #14 to capture this promotion.” In another embodiment, the consumer interface device 112a may present the consumer with an option to capture a promotion displayed on an aisle directory of an aisle other than the one in which the particular consumer interface device 112a is located in. In one embodiment, upon successfully capturing a selected promotion, the consumer interface device 112a or the display device 110a may provide a graphical confirmation, such as a pop-up graphical icon, to relate the user that the promotion has been captured.

Typically, in addition to capturing the promotion, the consumer may be required to procure or select a particular item for purchase, e.g. a particular brand of Cookies to which the captured promotion applies. Thus, after capturing a coupon or promotion, the consumer may continue with their shopping, over the course of which they may capture additional promotions on either the same or different aisle, for other products or services. When the consumer desires to complete their shopping, they will approach the checkout line or point-of-sale (POS) 116a, 116b. In one embodiment, the POS 116a includes a cash register, typically administered by a human attendant, although it may also be fully automated, such as a self checkout kiosk. In one embodiment, a point-of-sale (POS) 116a is a terminal which is used to process financial transactions, such as the purchase of items or goods using cash, credit, or other payment means.

In one embodiment, POS 116a is communicatively coupled to server 102. At checkout, the consumer identifies themselves so that they any promotions for which they are eligible may be processed. In one embodiment, the consumer identifies themselves in a similar manner as they did when capturing a promotion. For example, the consumer may provide personal information to the POS 116a by directly entering the information at the POS 116a (e.g. via a keypad), swiping a loyalty card such as a magnetic strip card or a barcode. In another embodiment, the consumer may relay identifying information to the POS attendant who subsequently enters it into the POS 116a. Once the consumer information is provided at the POS 116a, the information is transmitted to the server 102 for processing. In particular, in one embodiment, the server 102 determines which promotions have been captured by the consumer, or which promotions are associated with the consumer identification, and thus which promotions are available to the consumer if conditions associated with the promotion are satisfied at the POS 116a. For example, if the consumer captured a 50% off coupon for Cookies via the consumer interface device 112a in aisle 106a, once the consumer information is transmitted to the server 102, server 102 would transmit information to the POS 116a indicating that the consumer is eligible for the promotion if the conditions are met.

At the POS 116a, the items are presented for purchase by the consumer, e.g. at a checkout, to be registered. For example, the items may be scanned using their Universal Product Code (UPC) barcode label, by manually typing in an associated product identification, or other known methods. Upon registering the items, the price associated with the item is determined and may be presented to the user, for example, as each item is scanned. In one embodiment, information in addition to the price may be presented, such as nutritional information for the product. In one embodiment, once all items have been registered at the POS 116a, the POS 116a determines whether any of promotions which the consumer has captured have been satisfied. In another embodiment, this determination is made by server 102. For example, once all items have been registered at POS 116a, and the particular brand of Cookies for which the consumer captured a 50% off coupon has been registered, the 50% discount is applied to the purchase of the particular Cookies product.

In the embodiments described above, the system 100 may include a plurality of aisle directories 108a, 108b. In one embodiment, a plurality of aisle directories are associated with a single aisle. In another embodiment, an aisle may include a plurality of consumer interface devices 112a, 112b, 112c. In yet another embodiment, the system 100 may include a plurality of point-of-sale locations 116a, 116b.

Server 102 may be communicatively coupled to the aisle directories 108a, 108b, the consumer interface devices 112a, 112b, 112c, and the POS terminals 116a, 116b through either wired or wireless communication channels. For example, in one embodiment, server 102 is coupled to aisle directory 108b via a wireless connection complying with the IEEE 802.11 wireless standard. In another embodiment, server 102 may be coupled to the POS 116a through a connection using an Ethernet or other wired connection. Secure communication protocols may be used with the connectivity between the various components of embodiments of the invention, such as for example to encrypt data transmitted between devices.

In an alternate embodiment, the consumer interface device may be used by the consumer to download the promotion, for example, by downloading an electronic coupon into a portable storage device possessed by the consumer. The consumer may then present the storage device, which includes the electronic coupon, at the point-of-sale, where the promotion is applied to the sale. In one embodiment, the downloadable coupon is a coupon or promotion associated with the particular promotion then currently displayed on the display device 110a. In another embodiment, the consumer interface device is capable of printing or otherwise producing a physical coupon, such as a paper coupon, to the consumer for presentation at the point-of-sale to redeem the coupon or promotion. In one embodiment, the printed coupon is a coupon or promotion associated with the particular promotion then currently displayed on the display device 110a.

In embodiments where a consumer receives a printed coupon or downloading a coupon into a storage device, an increased level of privacy may be provided to the consumer, since the consumer is able to procure or download the promotion or coupon, without necessarily being required to provide personal information that may be used to identify that particular consumer. Thus, once an electronic coupon is downloaded to, for example, a smart card, or once a printed coupon is generated at the consumer interface device for the promotion then currently displayed on the aisle directory 108a display 110a, the consumer is then required to present either the smart card containing the electronic coupon, or the physical coupon itself, at the point-of-sale, after which the promotion is applied if the conditions are met (e.g. the product associate with the promotion is scanned at the POS for purchase).

In another embodiment, the consumer interface device may process financial transactions associated with the promotion displayed on the aisle directory. For example, if a service is advertised on the display device 110a, a consumer may be presented with an option to purchase the service through the consumer interface device, such as by swiping a credit or payment card. In yet another embodiment, a consumer may enter a sweepstakes or other contest by swiping their loyalty card or otherwise providing input at the consumer interface device.

In one embodiment, an aisle directory 108a, consumer interface device 112a, or both, may include a motion sensor. For example, using the motion sensor, when a consumer approaches the aisle 106a, a motion sensor on directory 108a or the consumer interface device 112a detects the consumer's approach, and may then take some action, such as changing the content displayed on the display device 110a.

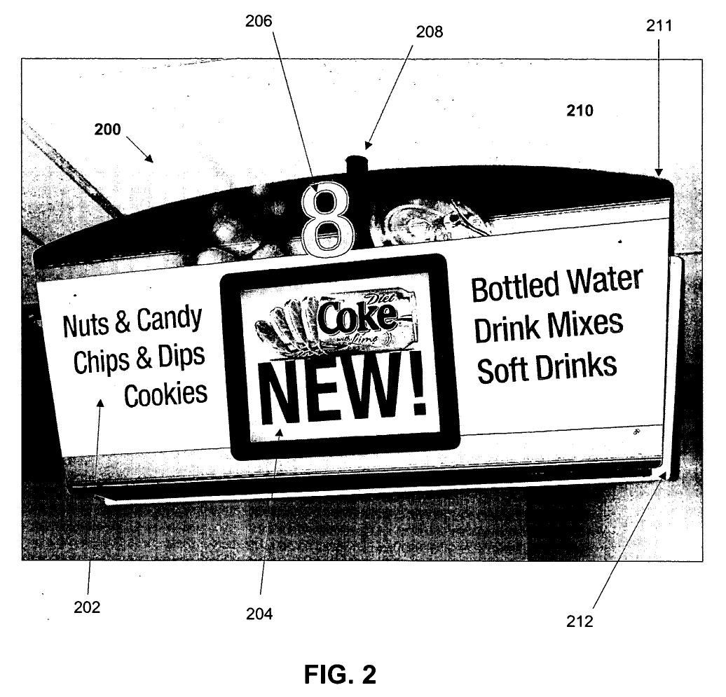

FIG. 2 illustrates an embodiment of an aisle directory 200. For example, in one embodiment, aisle directory 108a of FIG. 1 may have the characteristics of the aisle directory illustrated in FIG. 2. Aisle directory 200 includes listing 202 of the types of products, goods, or items that are located in or near the respective section of the store in which the aisle directory is positioned. The term section refers to a particular location within a store, and includes, for example, an aisle (e.g. Aisle 8), as well as a department or area within the store that is not necessarily limited to an aisle layout (e.g. the Bakery). Typically, the listing 202 on the left side of the aisle directory 200 indicates items found on the left side of the aisle from the perspective of the viewer, while the right side lists items found on the right side of the respective aisle. The aisle directory 200 may include the aisle number 206 or other identification of the section or department of the store to which it applies. For example, in the embodiment illustrated in FIG. 2, aisle directory 200 is associated with aisle “8”, as designated by the aisle number 206. In one embodiment, either of the aisle number 206 and the item listing 202 may be static, printed, or otherwise non-electronically presented. In another embodiment, either of the aisle number 206 or item listing 202 may be presented electronically, such as graphically through a display device.

Aisle directory 200 includes an electronic display device 204. As described above, the display 204 may be a display device, such as an LCD or CRT. In one embodiment, the display 204 presents graphical content, such as advertising or other promotional material. In one embodiment, the display 204 is coupled to a server or other content provider to receive promotional content for display, such as graphics, text, or video. In one embodiment, the promotional content displayed on display 204 is associated with at least one product or item located or available on the respective section or aisle 206 of the directory 200. In one embodiment, a server, either located remotely or proximate to the directory 200 controls the content displayed on the display 204. The display 204 may rotate through different displayed promotional content at various intervals.

In one embodiment, the aisle directory 200 may be suspended from a ceiling 210, as illustrated in FIG. 2. For example, in one embodiment, a cylindrical support member 208 anchors the directory 200 securely to the ceiling or supporting members such as a rafter or beam. In another embodiment, the aisle directory 200 may be a stand-alone kiosk that is placed within the aisle, section, or department (e.g. supported by the floor of the aisle). In yet another embodiment, the aisle directory 200 may be positioned above the aisle, though not necessarily supported from the ceiling. For example, in one embodiment, the aisle directory 200 may extend over the aisle from a shelf, e.g. the top shelf. In another embodiment, the aisle directory 200 may be positioned above the aisle from an arm extending from behind and over products positioned on the top shelf of one side of the aisle. In still yet another embodiment, directory information, as well as the promotional information displayed on aisle directory 200, may also be presented within the aisle by, for example, projecting directory and promotional information onto the floor from a projector positioned above the aisle.

In another embodiment, the directory 200 includes two display faces or sides 211, 212. For example, the directory 200 may include a display 204 on two opposing sides of the directory 200, each side 211, 212 having a listing of items and a display device 204. For example, directory 200 may include a front face 211 and a rear face 212 (note that in the embodiment illustrated in FIG. 2, the content of rear face 212 is not illustrated). This would facilitate use of the directory 200 from multiple viewing angles and locations. For example, by placing the directory 200 in approximately the center of an aisle, consumers traversing the aisle from either direction would be exposed to content displayed on the directory 200.

In another embodiment, the directory 200 may be placed proximate to an end of an aisle, increasing the likelihood that consumers positioned throughout the aisle might be facing the display 204, thereby increasing the exposure of promotional content to the consumer. In one embodiment, a single aisle may include a plurality of directories 200. In one embodiment, aisle directories similar to that illustrated in FIG. 2 are disposed in a plurality of aisles in a store. In still yet another embodiment, the aisle directory 200 may be placed in a section of the store that is outside of an aisle, for example, in the Bakery or Deli section or department of a grocery store. In such an embodiment, the display device of the aisle directory may present promotional content associated with products located in the particular section in which the aisle directory is placed.

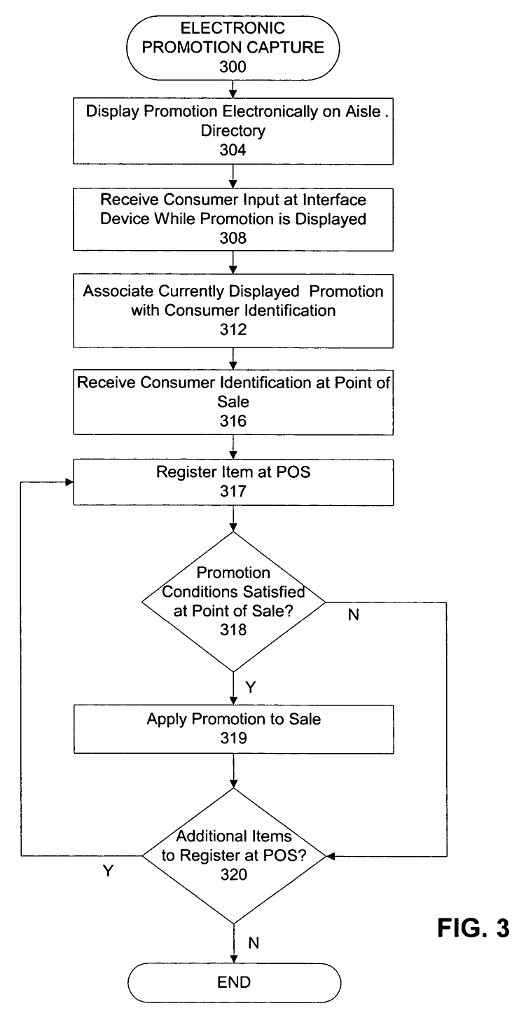

FIG. 3 illustrates an embodiment of an electronic promotion capture method 300. At block 304, the method 300 displays a promotion electronically on an aisle directory. In one embodiment, the promotion may be advertising content, for example, such as an advertisement for a discount on a product located on the aisle in which the promotion is displayed. If a consumer views the promotional content displayed on the aisle directory, the consumer may wish to participate in the promotion. If a consumer desires to participate in a promotion, the consumer approaches a consumer interface device located in the aisle. At block 308, the method 300 receives consumer input at a consumer interface device. For example, the consumer may swipe a magnetic card, scan a barcode, insert an electronic storage device, or enter information via a keypad at the consumer interface device. In one embodiment, the input provided by the consumer is relayed to a server where the consumer is uniquely identified and associated with a consumer identification, such as by an account number, based on the input received. At block 312, the method 300 associates the promotion that was currently displayed on the aisle directory at the time the consumer input was received, with the consumer identification. In one embodiment, this association is stored (e.g. in a database) for later use.

The consumer then may continue shopping and selecting items for purchase. When the consumer has completed their shopping, the consumer presents the items selected for purchase at a point-of-sale (POS) terminal. At block 316, the method receives consumer identification at the POS. For example, the consumer may identify themselves in the same manner in which they identified themselves at the consumer interface device, such as by swiping a magnetic card or scanning a barcode, inputting their name or phone number, etc. In one embodiment, the information received from the consumer is then relayed to the server, for example, to identify promotions that have been captured by the consumer or that are otherwise associated with the consumer identification. In one embodiment, at the POS, the consumer interface device, or both, secure communication protocols may be used to provide secure transmission of sensitive data, such as consumer identification information. For example, the Secured Sockets Layer (SSL) protocol may be used. SSL is a protocol that transmits communications over a network in an encrypted form.

At block 317, the method 300 receives identification of an item that is presented at the POS for purchase. For example, in one embodiment, each item is identified by scanning a UPC bar code or manually entering a description of the item into the cash register of the POS.

In one embodiment, at block 318, as each item is scanned or registered at the POS, the method 300 determines whether any of the promotions which have been captured by (or are associated with) the consumer have had their conditions met. For example, if a consumer captured a $2.00 off coupon for a particular product, the method 300 determines whether the consumer has presented that particular product at the POS for purchase.

If the method 300 determines at block 318 that conditions for a captured promotion have been met or satisfied (e.g. the consumer has presented the product associated with a captured promotion at the POS), the method 300 applies the promotion to the sale at block 319 (e.g. applies the coupon, reduces the purchase price of the item by 50%, etc.). The method 300 then determines at block 320 whether there are any additional items to register or scan at the POS. If there are additional items to register, the method 300 returns to block 317 to register the items.

If the method 300 determines at block 318 that the conditions for a captured promotion have not been met, the method 300 determines at block 320 whether there are any more items to register at the POS. If there are additional items to register, the method 300 returns to block 317 to register the items.

In an alternate embodiment, the electronic promotion capture method 300 determines whether the conditions of any captured promotions have been met only after all items are scanned or registered at the POS, rather than as each item is processed at the POS.

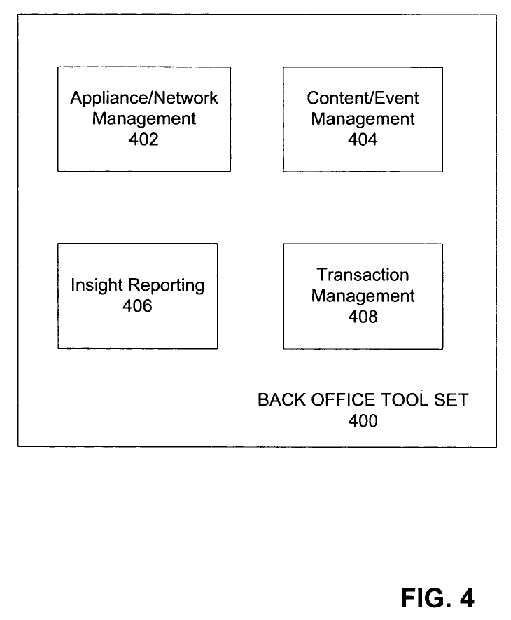

FIG. 4 illustrates an embodiment of a back office tool set 400. In one embodiment, the back office tool set is a group of component back end software applications used to manage the promotion capture systems and methods of the present invention. In one embodiment, the back office tool set is implemented using at least one remote server computer. In another embodiment, the back office tool set may be implemented on at least one server computer that is remotely coupled to a local server in a store, such as server 102 of FIG. 1. In yet another embodiment, the server 102 may implement the back office tool set 400 locally at the store site. In still yet another embodiment, where various components of the promotion capture system are directly communicatively coupled without using server 102 as a hub point, the various components may individually or collectively implement at least a portion of the back office tool set functions. For example, in one embodiment, an embedded device within the aisle directory 108a or consumer interface device 112a may implement the back office tool set functionality.

The back office tool set 400 includes an appliance and network management component 402, a content and event management component 404, an insight reporting component 406, and a transaction management component 408. In one embodiment, the back office tool set 400 includes web-based tools that are accessible remotely, for example, via the Internet through a web browser interface, to provide remote management and configuration capabilities for the promotion capture system.

The appliance and network management component 402 manages a network of appliances that are located in either a single store location or across a plurality of locations. In one embodiment, the appliance and network management component 402 manages both the network itself as well as individual appliances. Appliances include the display devices of the aisle directories, the consumer interface devices, the local store servers, and the POS systems of an individual store. For example, a single store location may include about ten to twelve aisle directories, each of which include hardware (e.g. the display device) and software components (e.g. the promotional content displayed on the display device). Appliance and network management component 402 includes a network management (or network operations) functionality, which ensures that the appliances are operating properly. For example, in one embodiment, the appliance and network management component 402 sends a status signal out to each appliance periodically (e.g. every hour) to monitor the appliances, to determine whether the appliance is operating properly. In one embodiment, where the back office tool set 400 is located remotely from the location of the store-level promotion capture system, the back office tool set 400 is coupled to the local store server (e.g. local store server 102 of FIG. 1) through a wide area network (WAN), such as the Internet. The appliance and network management component 402 communicates with individual appliances through the connection that is used locally in the store between the server and the appliance. For example, where the local in-store server is communicatively coupled to the aisle directory display device through a wireless network, the status and control signals from the back office tool set 400 components are transmitted to the local in-store server, then wirelessly routed from the store's access point to the appliance.

In one embodiment, the appliance and network management component 402 pulls session logs from the networked appliances to determine various statistics regarding the appliances and their use, such as how many consumer captured a particular coupon or promotion, how did consumers capture the coupon (e.g. by entering phone number, swiping a loyalty card, etc.). In addition, the appliance and network management component 402 retrieves and generates error logs that may exist for the appliances or appliance peripherals, such as whether the appliance rebooted or froze up, or encountered another type of error or malfunction.

Content and event management component 404 allows for the management of the content displayed on any of the appliances, such as the promotional content that is displayed on the display devices of the aisle directories, as well as management of the promotional events (e.g. when and where the promotion is to be displayed). Since the promotions are likely to be changing frequently (e.g. they run for limited periods of time, products are added or removed, prices are adjusted, graphics are altered, etc.), the content will often needs to be managed. In one embodiment, the content and event management component 404 allows a user to select, for example, the graphics and/or language that is displayed on the display device as part of a promotion. In another embodiment, the content and event management component 404 also allows a user to perform events management, i.e. management of promotion characteristics, such as for example the duration of the promotion, disbursement (e.g. which aisle, market, stores or geographical location to display the promotion, etc.), and timing for display of the promotion, such as what time of day or what particular days to display the promotion.

In one embodiment, a store may use the content and event management component 404 functionality to manage the content displayed on the display devices. For example, a store manager may want to run a special promotion for a store brand product. In another embodiment, a third party content manager may handle the promotions displayed in the store. For example, a marketing specialty company may manage the promotional content displayed in the store. In yet another embodiment, a product vendor may access and manage the promotional content that is displayed in the store by using the content and event management component 404.

In one embodiment, the content management and event component 404 includes an approval loop. The approval loop provides the parties involved an opportunity to approve the promotional content or event characteristics. For example, where a third party marketing company creates the promotional content and designates it for display at particular times in particular store locations, the approval loop allows the store as well as the vendor to approve or reject the promotional content or event characteristics before the promotion is implemented in the store. This may be useful where, for example, a vendor is concerned with maintaining a consistent brand identity, or where a store is concerned about the appropriateness of the content displayed on the display devices as part of the promotion.

Once promotional content and event characteristics have been approved using the content management component, the promotional content and the promotion event characteristics are published. In one embodiment, the publishing is handled by the content and event management component 404. For example, in one embodiment, an approved promotion is published by uploading the promotional content (e.g. graphics, video, audio, text, etc.) along with its respective event characteristics (e.g. time of display, frequency, location, etc.) to a store, such as through the store's local server or directly to the aisle directory.

The insight reporting component 406 provides statistical reporting for the promotion capture system, as well as reporting on aspects of the promotions themselves. For example, the reporting may include analyses of a particular promotion's efficacy, the number of consumers that captured the promotion, the time of day at which the promotion was captured (e.g. morning, afternoon or evening), store traffic measurements, and other analytically useful statistics that may be used to evaluate the degree of success of a particular promotion, or even the efficacy of a particular store's promotion capture system, for example, its layout.

The transaction management component 408 allows for the management of promotions for products or services that are not actually provided or stocked in the stores in which the promotion is run. For example, in one embodiment, if a promotion for a carpet cleaning service is displayed in an aisle directory of a grocery store, the consumer may capture the promotion, but the promotion is not performed at the store POS; rather, the carpet cleaning service would need to be notified that the consumer has captured the coupon, so that when the consumer identifies themselves to the carpet cleaning company, the promotion may be applied. In one embodiment, the transaction management component 408 would manage the notification of a third party, such as the carpet cleaning service, that a consumer has captured the displayed promotion. For example, in one embodiment, the notification may be in the form of an automatically generated email informing the third party that the promotion has been captured by a particular consumer.

In another embodiment, where a displayed promotion may be captured at the consumer interface device, the transaction management component 408 may handle both the notification to a third party vendor that the consumer has capture the promotion for the associated product or service. For example, where a displayed promotion is associated with a product or service not stocked at the particular store where the promotion was run (e.g. a promotion for tires run at a grocery store), the transaction management component 408 notifies the tire vendor that the consumer captured the promotion and thus is entitled to receive the promotion if any conditions are subsequently met.

In another embodiment, the transaction management component 408 may also process payment to a party other than the store where a particular promotion is displayed. For example, in an embodiment where the particular promotion displayed is one which allows for the consumer to instantly make a payment at the consumer interface device for a product or service associated with the displayed promotion, the transaction management component 408 processes the payment. In one embodiment, where the promotion is for a product or service not available from the store in which the promotion is displayed, the transaction management component 408 is capable of forwarding the payment and/or consumer information (e.g. delivery address information) to the third party supplier.

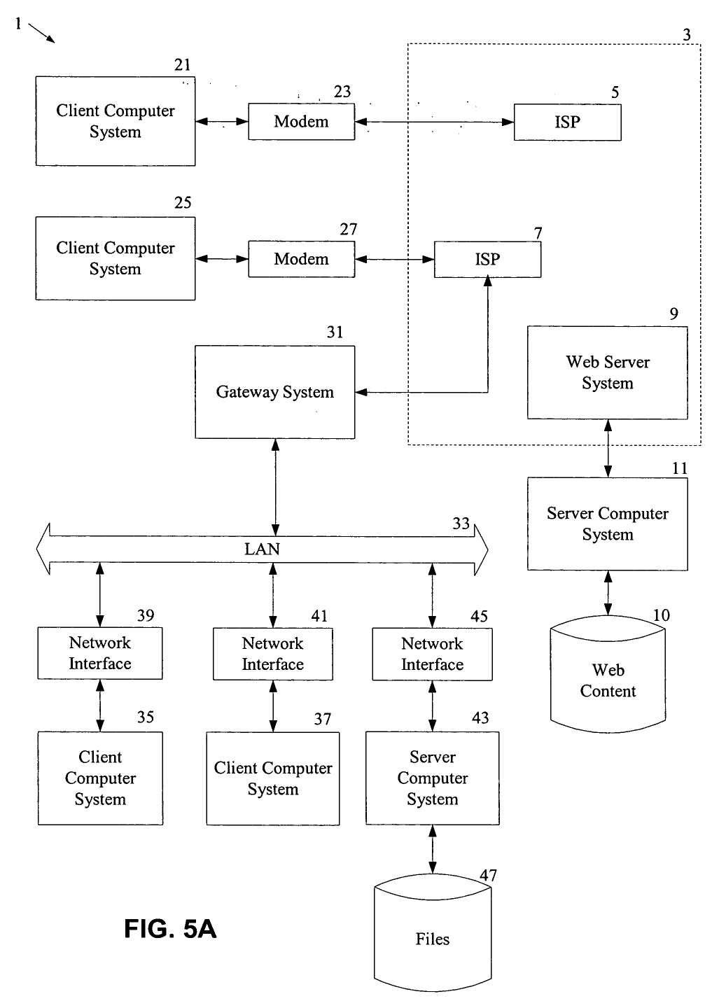

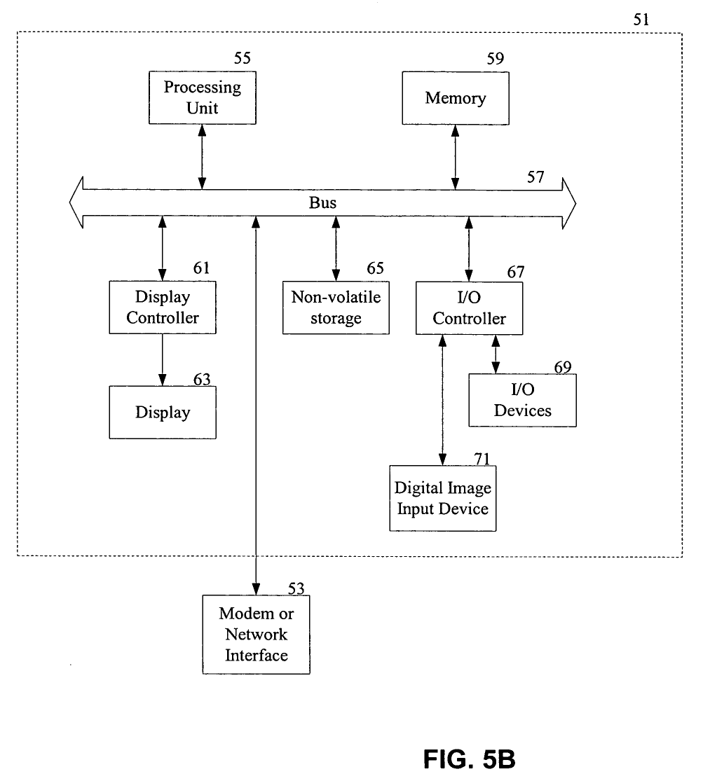

The following description of FIGS. 5A and 5B is intended to provide an overview of computer hardware and other operating components suitable for implementing embodiments of the invention described herein, but is not intended to limit the applicable environments. One of skill in the art will immediately appreciate that the invention can be practiced with other computer system configurations, including hand-held devices, cellular telephones, multiprocessor systems, microprocessor-based or programmable consumer electronics/appliances, network PCs, minicomputers, mainframe computers, embedded devices or PCs, and the like. Embodiments of the invention can also be practiced in distributed computing environments where tasks are performed by remote processing devices that are linked through a communications network.

FIG. 5A shows several computer systems 1 that are coupled together through a network 3, such as the Internet. The term “Internet” as used herein refers to a network of networks which uses certain protocols, such as the TCP/IP protocol, and possibly other protocols such as the hypertext transfer protocol (HTTP) for hypertext markup language (HTML) documents that make up the World Wide Web (web). The physical connections of the Internet and the protocols and communication procedures of the Internet are well known to those of skill in the art. Access to the Internet 3 is typically provided by Internet service providers (ISP), such as the ISPs 5 and 7. Users on client systems (or kiosks), such as client computer systems 21, 25, 35, and 37 obtain access to the Internet through the Internet service providers, such as ISPs 5 and 7. Access to the Internet allows users of the client computer systems to exchange information, receive and send emails and instant messages, and view documents, such as documents which have been prepared in the HTML format. These documents are often provided by web servers, such as web server 9 which is considered to be “on” the Internet. Often these web servers are provided by the ISPs, such as ISP 5, although a computer system can be set up and connected to the Internet without that system being also an ISP as is well known in the art.

The web server 9 is typically at least one computer system which operates as a server computer system and is configured to operate with the protocols of the World Wide Web and is coupled to the Internet. Optionally, the web server 9 can be part of an ISP which provides access to the Internet for client systems. The web server 9 is shown coupled to the server computer system 11 which itself is coupled to web content 10, which can be considered a form of a media database. It will be appreciated that while two computer systems 9 and 11 are shown in FIG. 5A, the web server system 9 and the server computer system 11 can be one computer system having different software components providing the web server functionality and the server functionality provided by the server computer system 11 which will be described further below.

Client computer systems 21, 25, 35, and 37 can each, with the appropriate web browsing software, view HTML pages provided by the web server 9. The ISP 5 provides Internet connectivity to the client computer system 21 through the modem interface 23 which can be considered part of the client computer system 21. The client computer system can be a personal computer system, consumer electronics/appliance, a network computer, a Web TV system, a handheld device, or other such computer system. Similarly, the ISP 7 provides Internet connectivity for client systems 25, 35, and 37, although as shown in FIG. 5A, the connections are not the same for these three computer systems. Client computer system 25 is coupled through a modem interface 27 while client computer systems 35 and 37 are part of a LAN. While FIG. 5A shows the interfaces 23 and 27 as generically as a “modem,” it will be appreciated that each of these interfaces can be an analog modem, ISDN modem, DSL modem, cable modem, satellite transmission interface, or other interfaces for coupling a computer system to other computer systems. Client computer systems 35 and 37 are coupled to a LAN 33 through network interfaces 39 and 41, which can be Ethernet network or other network interfaces. The LAN 33 is also coupled to a gateway computer system 31 which can provide firewall and other Internet related services for the local area network. This gateway computer system 31 is coupled to the ISP 7 to provide Internet connectivity to the client computer systems 35 and 37. The gateway computer system 31 can be a conventional server computer system. Also, the web server system 9 can be a conventional server computer system.

Alternatively, as well-known, a server computer system 43 can be directly coupled to the LAN 33 through a network interface 45 to provide files 47 and other services to the clients 35, 37, without the need to connect to the Internet through the gateway system 31.

FIG. 5B shows one example of a conventional computer system that can be used as a client computer system or a server computer system or as a web server system. It will also be appreciated that such a computer system can be used to perform many of the functions of an Internet service provider, such as ISP 5. The computer system 51 interfaces to external systems through the modem or network interface 53. It will be appreciated that the modem or network interface 53 can be considered to be part of the computer system 51. This interface 53 can be an analog modem, ISDN modem, DSL modem, cable modem, token ring interface, satellite transmission interface, or other interfaces for coupling a computer system to other computer systems. The computer system 51 includes a processing unit 55, which can be a conventional microprocessor such as a G3, G4, or G5 microprocessor from Motorola, Inc. or IBM, a Motorola Power PC microprocessor, or an Intel Pentium microprocessor. Memory 59 is coupled to the processor 55 by a bus 57. Memory 59 can be dynamic random access memory (DRAM) and can also include static RAM (SRAM), among other types of well-known memory devices. The bus 57 couples the processor 55 to the memory 59 and also to non-volatile storage 65 and to display controller 61 and to the input/output (I/O) controller 67. The display controller 61 controls in the conventional manner a display on a display device 63 which can be a cathode ray tube (CRT) or liquid crystal display (LCD). The input/output devices 69 can include a keyboard, disk drives, printers, a scanner, and other input and output devices, including a mouse or other pointing device. The display controller 61 and the I/O controller 67 can be implemented with conventional well known technology. A digital image input device 71 can be a digital camera which is coupled to an I/O controller 67 in order to allow images from the digital camera to be input into the computer system 51. The non-volatile storage 65 is often a magnetic hard disk, an optical disk, or another form of storage for large amounts of data. Some of this data is often written, by a direct memory access process, into memory 59 during execution of software in the computer system 51. One of skill in the art will immediately recognize that the terms “computer-readable medium” and “machine-readable medium” include any type of storage device that is accessible by the processor 55 and also encompass a carrier wave that encodes a data signal.

It will be appreciated that the computer system 51 is one example of many possible computer systems which have different architectures. For example, personal computers based on an Intel microprocessor often have multiple buses, one of which can be an input/output (I/O) bus for the peripherals and one that directly connects the processor 55 and the memory 59 (often referred to as a memory bus). The buses are connected together through bridge components that perform any necessary translation due to differing bus protocols.

Network computers are another type of computer system that can be used with the present invention. Network computers do not usually include a hard disk or other mass storage, and the executable programs are loaded from a network connection into the memory 59 for execution by the processor 55. A Web TV system, which is known in the art, is also considered to be a computer system according to the present invention, but it may lack some of the features shown in FIG. 5B, such as certain input or output devices. A typical computer system will usually include at least a processor, memory, and a bus coupling the memory to the processor.

It will also be appreciated that the computer system 51 is controlled by operating system software which includes a file management system, such as a disk operating system, which is part of the operating system software. The file management system is typically stored in the non-volatile storage 65 and causes the processor 55 to execute the various acts required by the operating system to input and output data and to store data in memory, including storing files on the non-volatile storage 65.

The present invention may also be embodied in an embedded, handheld or portable device containing a subset of the computer hardware components described above in the computer system 51. For example, the handheld device may be configured to contain only the bus 57, the processor 55, and memory 59 and/or 65. The present invention may also be embodied in a special purpose appliance, such as a kiosk, including a subset of the computer hardware components described above. For example, the appliance may include a processor 55, a data storage device 65, a bus 57, and memory 59, and only rudimentary communications mechanisms, such as a small touch-screen that permits the user to communicate in a basic manner with the device. In general, the more special-purpose the device is, the fewer of the elements need be present for the device to function. In some devices, communications with the user may be through a touch-based screen, or similar mechanism.

The methods described herein constitute computer programs made up of computer-executable instructions illustrated as blocks (acts) within the flow chart of FIG. 3. Describing the methods by reference to a flow chart enables one skilled in the art to develop such programs including such instructions to carry out the methods on suitably configured computers (the processor of the computer executing the instructions from computer-readable media, including memory). The computer-executable instructions may be written in a computer programming language or may be embodied in firmware logic. If written in a programming language conforming to a recognized standard, such instructions can be executed on a variety of hardware platforms and for interface to a variety of operating systems. In addition, embodiments of the invention are not described with reference to any particular programming language. It will be appreciated that a variety of programming languages may be used to implement the teachings of the invention as described herein. Furthermore, it is common in the art to speak of software, in one form or another (e.g., program, procedure, process, application, module, logic . . . ), as taking an action or causing a result. Such expressions are merely a shorthand way of saying that execution of the software by a computer causes the processor of the computer to perform an action or produce a result. It will be appreciated that more or fewer processes may be incorporated into the method illustrated in FIG. 3 without departing from the scope of the invention and that no particular order is implied by the arrangement of blocks shown and described herein.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize. These modifications can be made to the invention in light of the above detailed description. The terms used in the following claims should not be construed to limit the invention to the specific embodiments disclosed in the specification and the claims. Rather, the scope of the invention is to be determined entirely by the following claims, which are to be construed in accordance with established doctrines of claim interpretation.

What is claimed is:

1. A system comprising:
a directory for an section, the directory including an electronic display device to display content associated with a promotion; and
an interface device located within the section, the interface device capable of receiving input associated with a consumer identification, wherein the interface device is capable of associating the promotion with the consumer identification.

2. The system of claim 1, further comprising:
a point-of-sale (POS) terminal, the POS terminal to apply the promotion to a transaction, wherein the transaction satisfies conditions of the promotion.

3. The system of claim 1, wherein the interface device is selected from the group consisting of a card reader, an optical scanner, a keypad, and a biometric device.

4. The system of claim 1, further comprising a plurality of interface devices.

5. The system of claim 1, wherein the content associated with the promotion is selected from the group consisting of graphics, video, and text.

6. The system of claim 1, wherein the directory includes a listing of items located in the section.

7. The system of claim 6, wherein an item associated with the promotion is located within the section.

8. The system of claim 1, wherein the directory is suspended above the section.

9. The system of claim 1, wherein the directory includes a plurality of electronic display devices to display content associated with a plurality of promotions.

10. The system of claim 1, wherein the interface device is communicatively coupled to the directory.

11. The system of claim 1, wherein the section is an aisle.

12. A method comprising:
displaying content on an electronic display device of a directory for a section, the content associated with a promotion;
receiving input associated with a consumer identification at an interface device located in the section; and
associating the promotion with the consumer identification.

13. The method of claim 12, wherein the directory includes a listing of items available in the section.

14. The method of claim 13, wherein the section is an aisle.

15. The method of claim 13, wherein the section is a department.

16. The method of claim 12, further comprising:
receiving input associated with the consumer identification at a point-of-sale (POS);
determining whether the promotion is associated with the consumer identification; and
determining whether a condition of the promotion is satisfied at the POS.

17. The method of claim 16, further comprising applying the promotion to a sale at the POS if the condition of the promotion is satisfied at the POS.

18. The method of claim 12, wherein the promotion includes a discount on a product available in the section.

19. The method of claim 18, wherein the directory is located in the section.

20. The method of claim 12, wherein the promotion is associated with the consumer identification while the content associated with the promotion is displayed on the electronic display device.

21. The method of claim 12, wherein the interface device is selected from the group consisting of a card reader, an optical scanner, a keypad, and a biometric device.

22. The method of claim 12, wherein the content associated with the promotion is selected from the group consisting of graphics, video, and text.

23. The method of claim 12, wherein the interface device is communicatively coupled to the directory.

24. A machine-readable medium having instructions to cause a machine to perform a machine-implemented method comprising:
displaying content on an electronic display device of a directory for a section, the content associated with a promotion;
receiving input associated with a consumer identification at an interface device located in the section; and
associating the promotion with the consumer identification.

25. The machine-readable medium of claim 24, wherein the directory includes a listing of items available in the section.

26. The machine-readable medium of claim 25, wherein the section is an aisle.

27. The machine-readable medium of claim 25, wherein the section is a department.

28. The machine-readable medium of claim 24, wherein the method further comprises:
receiving input associated with the consumer identification at a point-of-sale (POS);
determining whether the promotion is associated with the consumer identification; and
determining whether a condition of the promotion is satisfied at the POS.

29. The machine-readable medium of claim 28, wherein the method further comprises applying the promotion to a sale at the POS if the condition of the promotion is satisfied at the POS.

30. The machine-readable medium of claim 24, wherein the promotion includes a discount on a product available in the section.

31. The machine-readable medium of claim 30, wherein the directory is located in the section.

32. The machine-readable medium of claim 24, wherein the promotion is associated with the consumer identification while the content associated with the promotion is displayed on the electronic display device.

33. The machine-readable medium of claim 24, wherein the interface device is selected from the group consisting of a card reader, an optical scanner, a keypad, and a biometric device.

34. The machine-readable medium of claim 24, wherein the content associated with the promotion is selected from the group consisting of graphics, video, and text.

35. The machine-readable medium of claim 24, wherein the interface device is communicatively coupled to the directory.

36. An apparatus comprising:
means for displaying content on an electronic display device of a directory for a section, the content associated with a promotion;
means for receiving input associated with a consumer identification at an interface device located in the section; and
means for associating the promotion with the consumer identification.

37. The apparatus of claim 36, wherein the directory includes a listing of items available in the section.

38. The apparatus of claim 37, wherein the section is an aisle.

39. The apparatus of claim 37, wherein the section is a department.

40. The apparatus of claim 36, further comprising:
means for receiving input associated with the consumer identification at a point-of-sale (POS);
means for determining whether the promotion is associated with the consumer identification; and
means for determining whether a condition of the promotion is satisfied at the POS.

41. The apparatus of claim 40, further comprising means for applying the promotion to a sale at the POS if the condition of the promotion is satisfied at the POS.

42. The apparatus of claim 36, wherein the promotion includes a discount on a product available in the section.

43. The apparatus of claim 42, wherein the directory is located in the section.

44. The apparatus of claim 36, wherein the promotion is associated with the consumer identification while the content associated with the promotion is displayed on the electronic display device.

45. The apparatus of claim 36, wherein the interface device is selected from the group consisting of a card reader, an optical scanner, a keypad, and a biometric device.

46. The apparatus of claim 36, wherein the content associated with the promotion is selected from the group consisting of graphics, video, and text.

47. The apparatus of claim 36, wherein the interface device is communicatively coupled to the directory.

48. A system comprising:
a processing unit coupled to a memory through a bus; and
a process executed from the memory by the processing unit to cause the processing unit to:
display content on an electronic display device of a directory for a section, the content associated with a promotion;
receive input associated with a consumer identification at an interface device located in the section; and
associate the promotion with the consumer identification.

49. The system of claim 48, wherein the directory includes a listing of items available in the section.

50. The system of claim 49, wherein the section is an aisle.

51. The system of claim 49, wherein the section is a department.

52. The system of claim 48, wherein the process further causes the processing unit to:
receive input associated with the consumer identification at a point-of-sale (POS);
determine whether the promotion is associated with the consumer identification; and
determine whether a condition of the promotion is satisfied at the POS.

53. The system of claim 52, wherein the process further causes the processing unit to apply the promotion to a sale at the POS if the condition of the promotion is satisfied at the POS.

54. The system of claim 48, wherein the promotion includes a discount on a product available in the section.

55. The system of claim 54, wherein the directory is located in the section.

56. The system of claim 48, wherein the promotion is associated with the consumer identification while the content associated with the promotion is displayed on the electronic display device.

57. The system of claim 48, wherein the interface device is selected from the group consisting of a card reader, an optical scanner, a keypad, and a biometric device.

58. The system of claim 48, wherein the content associated with the promotion is selected from the group consisting of graphics, video, and text.

59. The system of claim 48, wherein the interface device is communicatively coupled to the directory.
